(19) United States
(12) Patent Application Publication
(10) Pub. No.: US 2012/0260843 A1
(43) Pub. Date: Oct. 18, 2012

(54) Solar powered, mobile trailer goose controller

(76) Inventor: Robin Zweesaardt, Monmouth Junction, NJ (US)

(21) Appl. No.: 13/066,319

(22) Filed: Apr. 13, 2011

(51) Int. Cl. A01M 29/16

(52) U.S. Cl. 116/22 A

(57) ABSTRACT

A towable, single axle utility trailer having a support platform, a rearwardly angled frame at a front end, a support column at a rear end, control units on the angled frame to generate timed electrical signals representative of geese recordings of alert and alarm, audio speakers on legs of the support column for sounding alarms of multiple geese in motion and at different levels of distress, and a solar panel collector atop the support column for energizing a storage battery in providing the electrical power required to operate the speakers and control units.

### CROSS-REFERENCE TO RELATED APPLICATIONS

NONE.

### STATEMENT REGARDING FEDERALLY SPONSORED RESEARCH OR DEVELOPMENT

Research and development of this invention and Application have not been federally sponsored, and no rights are given under any Federal program.

### REFERENCE TO A MICROFICHE APPENDIX

NOT APPLICABLE

### BACKGROUND OF THE INVENTION

1. Field of the Invention

This invention relates to repelling infesting geese and ridding them from large areas where troubling geese congregate.

2. Description of the Related Art

Each year, millions of geese invade everything from office complexes to parks and golf courses, leaving unsightly fecal matter that causes destruction to grasses and increases fecal coliform levels in ponds. The money spent cleaning, reseeding, resodding and repairing is more than most companies and communities feel comfortable spending. Unfortunately, with the population of geese increasing at a rate of 30% per year, and with geese in the millions, the problem is getting continually worse—not only at industrial and community complexes, but in open fields and at large lawn areas, in general.

### SUMMARY OF THE INVENTION

As will become clear from the following description, a goose chaser in accordance with the present invention comprises a lightweight mobile trailer and a solar powered controller unit that sounds alerts and alarms which make the troublesome geese perceive that the area is already populated by flocks of geese at various levels of distress. Occurring in random combinations of amplitude, frequency and duration, these types of calls will be appreciated as both indicating an uneasiness of potential danger, on the one hand, and as signifying an immediate danger, on the other hand. Realistic and waterproof visual decoys (such as imitation foxes and coyotes) may be used to supplement the deterrent provided, along with other devices designed to scare away troubling geese.

As will also be understood, goose chasing is generally not a one-time solution—as presently attempted by sounding horns or audible alerts to scare them from parks, golf courses, office complexes, apartments, warehouses, recreational facilities, educational facilities and campuses. Even though geese are territorial and stubbornly return to the same place annually, these latter types of soundings provide only a temporary relief, less than optimum, in preventing the geese from landing. With the operation of the present invention conveying to the troublesome geese that the area is already populated by flocks of geese in a state of anxiety and distress, the geese then remember that what was once their territory is then under some form of attack—and the geese turn away. Testing has shown that once a goose has been successfully scared away, any such return is rare.

The solar powered goose controller of the invention will be seen to be transportable as a lightweight, mobile trailer unit to be towed to whatever area or location is then in danger of such goose infestation, to repel the geese away.

### BRIEF DESCRIPTION OF THE DRAWINGS

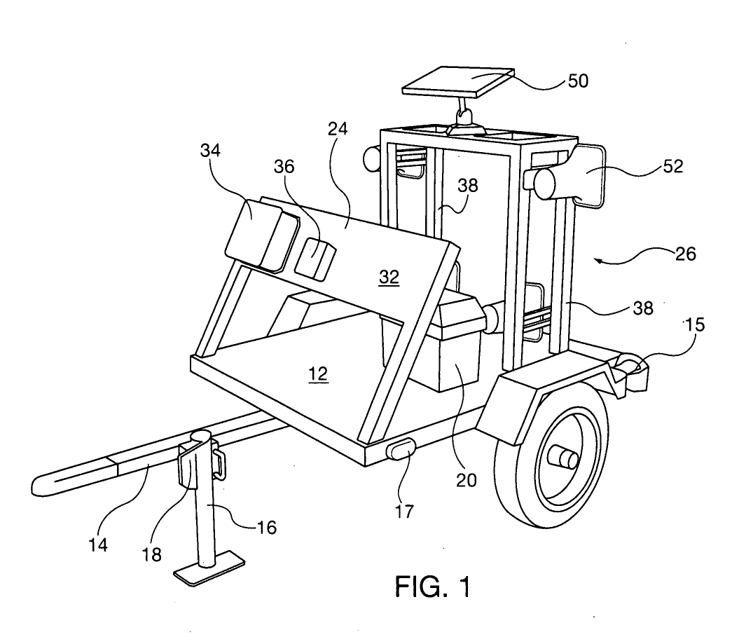

These and other features of the present invention will be more clearly understood from a consideration of the following description, taken in connection with the accompanying drawings, in which FIGS. 1-5 are pictorial views of the solar powered, mobile trailer goose controller unit of the invention in different phases of use.

### DETAILED DESCRIPTION OF THE INVENTION

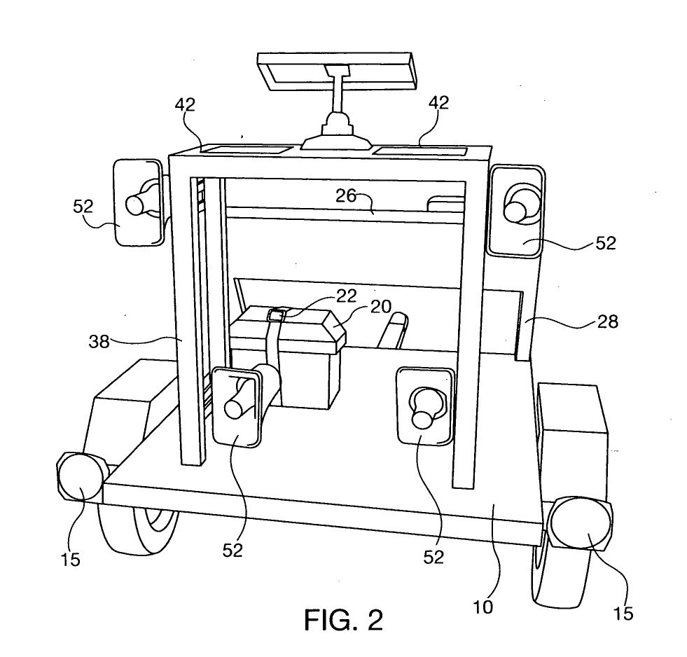

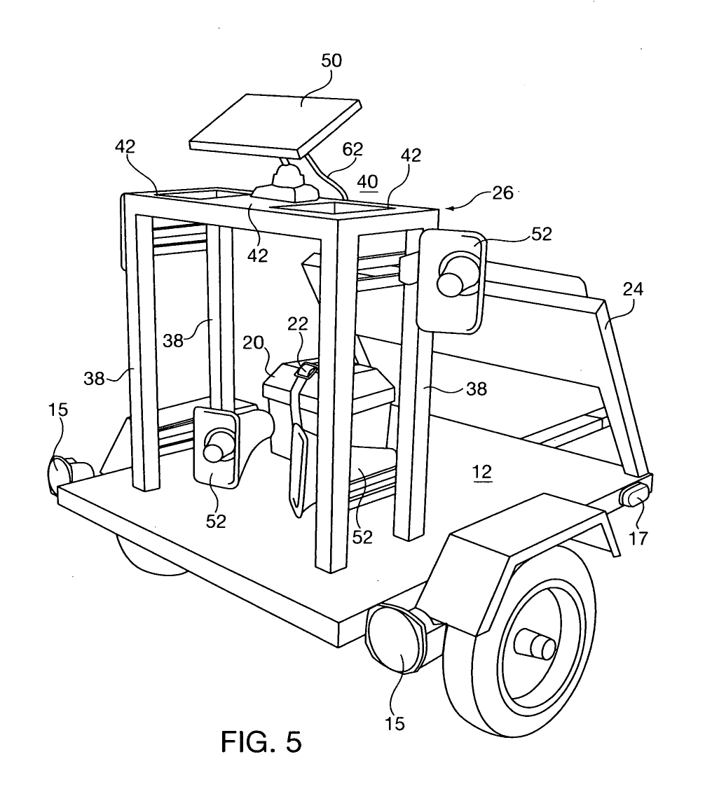

In FIGS. 1-5, the towable utility trailer of the invention is shown at 10 as having a support platform 12. A front towbar 14 couples to a pulling vehicle and a stabilizing outrigger support 16 with a hand crank winch 18 stabilizes the towbar when the controller is displayed for use. A storage battery 20—preferably of 12 volt capacity—is secured to the support platform 12 by a strap 22. A pair of tail lights for the trailer are shown at 15, and a pair of side lights are shown at 17. The support platform 12 includes an angled frame 24 at a front end of the platform, and a support column 26 at its rear end. The frame 24 includes first and second arms 28, 30 extending upwardly from the platform to join with opposite ends of a third arm 32 upon which first and second control units 34, 36 are fixedly mounted. The support column 26, on the other hand, comprises four legs 38 extending upwardly from the platform to form a top plane 40 with four joining arms 42. As more particularly shown in FIG. 1, the frame 24 is angled rearwardly at the front end of the support platform, while the support column 26 extends upwardly from the platform a greater amount than does the frame 24. A solar panel collector 50 for the storage battery 20 is secured across two of the four arms forming the top plane 40 of the support column 26. Four audio speakers 52 are secured to the column 26, one to each of its legs. Preferably, the speakers 52 are hingedly mounted to the legs so as to be rotatable through 90° , to point rearwardly, as in FIG. 2, or to the sides, as in FIG. 5.

In accordance with the invention, the first control unit 34 is of a type capable of generating electrical signals representative of geese recordings, adjustable in amplitude, frequency and duration. Such a unit is available from BIRD-X, INC. of Chicago, Ill. As its GOOSEBUSTER repeller, in which signal combinations and sequences can be randomly changed to cause geese to perceive multiple birds in motion and at different levels of distress when played through audio speakers. The second control unit 36, on the other hand, is in the nature of a timer, providing a series of time switches for establishing the times of sound generation from the speakers 52, and the intervals between them. A timer available as the FM/1 Series Time switch from Grasslin Controls Corporation of Mahwah, New Jersey is particularly suitable in offering 24-hour or 7-day scheduling on 15 minute intervals.

Electrical power is coupled from the battery 20 to the timer 36, and from the timer 36 to the signal generator controller 34. The output signals of the controller are coupled individually to each of the speakers 52. The various couplings are illustrated enclosed within a flex cable tube 55.

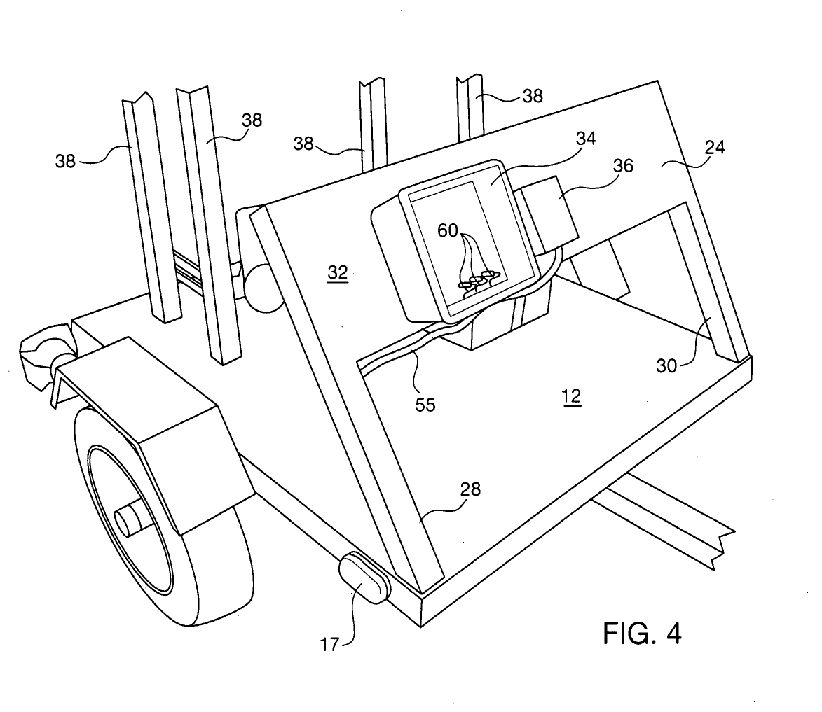

FIG. 4 illustrates plug in connections 60 for the audio speaker 52 to the control unit 34 and FIG. 5 illustrates the mounting of the solar panel collector 50 to the top plane 40 and its cable coupling 62 to the storage battery 20. Such mounting of the collector may be fixed, or preferably pivotable to capture as much sunlight as possible. In this respect, as FIG. 1 illustrates, the support column 26 upwardly extends from the platform 12 an amount greater than the frame 24 upwardly extends from the platform, to gather as much sunlight as possible. In use, all that becomes necessary is to couple the front tow bar 14 to a towing vehicle in any appropriate manner, and then drive the solar powered, mobile trailer goose controller of the invention to the area or location to be protected. The tow bar could there be decoupled, and the hand crank winch 18 deployed with the outrigger support 16 in stabilizing the tow bar at a selected height above the ground. The individual selectors of the control unit 34 are then set, the individual selections of the timer 36 established, and the goose controller then left, confident that the alert and/or alarm calls will be sounded at the time designations chosen, and for the amplitudes, frequencies and durations deemed best appropriate to repel any geese that may come to infest the area, or to rid those that are already present there. Afterwards, the tow bar 14 could just be re-coupled to the towing vehicle, the various controls and timings deactivated, and the goose controller then being driven to the next location of interest, or just placed in storage.

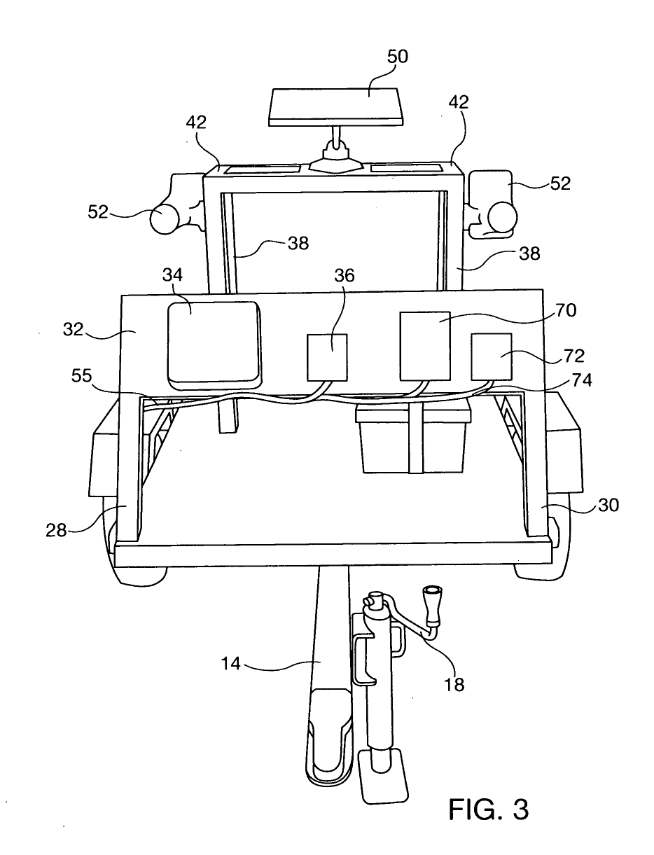

As will also be appreciated, various visual decoys may be added to operate with the goose controller as a repeller, in the nature of various displays of imitation foxes and coyotes, or other antagonists of populating geese. In similar manner, like additional sounding can be utilized as well to effectively repel transitory geese—such as hunter gunshot recordings and other sounds frightening to geese. And, as FIG. 3 illustrates, a further feature of the invention is to construct the arm 32 of the angled frame 24 both sufficiently wide and long for the attachment not only of the signal generating control 34 and its time switch control 36, but to also allow sufficient space to mount other types of sound controllers and timers to rid an area of additional unwanted animals or birds. Generally shown as the control unit 70 and its own timer 72, a further flex tube 74 could be added to enclose couplings to these units from the battery 20 in deterring deer, ground hogs, wild turkeys, etc.

The solar powered, mobile trailer controller of the invention could then be used in a similar manner to rid those areas where such animals/birds may graze or inhabit either with the same wire connections to the audio speakers 52, or to other sound generating devices. One such repeller that might be employed in this manner could be the CRITTERBLASTER available from BIRD-X, INC.

While there have been described what are considered to be preferred embodiments of the present invention, it will be readily acknowledged by those skilled in the art that as long as the control units 34, 36, the control units 70, 72 the audio speakers 52 and the solar panel collector 50 can be reached for adjustment, modifications can be made without departing from the scope of the teachings herein. For at least such reason, therefore, resort should be had to the claims appended hereto for a true understanding of the invention.

I claim:

1. A deployable controller for large area goose deterrence comprising:
a towable utility trailer having a support platform, a frame upwardly extending from a front end of the platform and a support column upwardly extending from a rear end of the platform;
a storage battery on the platform;
a solar powered panel on a top portion of said support column;
a sonic goose repeller and a programmable timer on said frame;
a first electric cabling connecting said battery to said timer;
a second electric cabling connecting said timer to said repeller to control ON and OFF times of sonic goose repeller operation; and
a plurality of audio speaks individually mounted at spaced locations of said support column;
wherein said sonic goose repeller couples electrical signals of controllable amplitude, frequency and duration to each of said speakers to provide goose deterrent sound

2. The controller of claim 1 wherein said solar powered panel is pivotable atop said support column.

3. The controller of claim 1 wherein said utility trailer includes a front tow bar to which a stabilizing outrigger support is coupled to support the tow bar on the ground.

4. The controller of claim 3 wherein said outrigger support is deployable by a hand crank winch.

5. The controller of claim 1 wherein said support column upwardly extends from the rear end of said platform an amount greater than said frame upwardly extends from the front end of said platform.

6. The controller of claim 5 wherein said frame extends upwardly at a rearward angle from the front end of said platform.

7. The controller of claim 1 wherein said storage battery is of 12 volt capacity.

8. The controller of claim 1 wherein said support column includes four upwardly extending vertical legs, to each one of which an audio speaker is mounted to sound said goose deterrent

9. The controller of claim 8 wherein each of said speakers is pivotably secured to a support column leg to rotate outwardly to the side and rearwardly to the back of said platform.

10. The controller of claim 9 wherein each of said four vertical legs has one end secured to said platform and a second end individually joined with one of four arms to form said top portion of said column.

11. The controller of claim 10, also including a solar panel collector included between two arms of said top portion to which said solar powered panel is mounted.

12. The controller of claim 11 wherein said solar panel collector is fixed or pivotably mounted with respect to said top
